(19) United States
(12) Patent Application Publication
(10) Pub. No.: US 2002/0052445 A1
(43) Pub. Date: May 2, 2002

(54) Biodegradable film

(76) Inventors: Shigenori Terada, Shiga (JP); Jun Takagi, Tokyo (JP)

Correspondence Address: Wenderoth Lind & Ponack LLP, 2033 K Street NW, Suite 800, Washington, DC, 20006, US

(21) Appl. No.: 09/566,625

(22) Filed: May 8, 2000

Related U.S. Application Data
(63) Continuation-in-part of application No. 09/175,562, filed on Oct. 20, 1998, now abandoned.

(51) Int. Cl. C08L 67/00

(52) U.S. Cl. 525/185; 525/186; 525/190; 525/437; 525/450; 525/411; 525/413; 523/114

(57) ABSTRACT

A film degradable in natural environment and high in both flexibility and transparency. A biodegradable film comprises a polymer of polylactic acid family and an aliphatic polyester other than polylactic acid in a weight ratio of from 70:30 to 20:80, said film having a tensile modulus of not more than 250 kg/mm² and a light transmittance of not less than 65%.

### BACKGROUND OF THE INVENTION

The present invention relates to a film degradable in natural environment and high in flexibility and transparency.

Conventional plastic products, and particularly plastic packaging materials, are usually discarded after use. How to dispose of them is a big problem. Typical packaging plastics include polyethylene, polypropylene and polyethylene telephthalate (PET). These materials produce much heat when burned and thus can damage incinerators during burning. Further, polyvinyl chloride, which is used extensively even today, cannot be burned due to its self-extinguishing property. Plastic products including self-extinguishing plastics are often dumped and buried. After buried, they remain in the ground without degrading due to their chemical and biological stability, thus shortening the life of dumping sites. Thus, plastic products that produce less heat when burned, are safe and degradable in the ground are desired, and efforts are being made to develop such plastic materials.

One example that meets these requirements is a polylactic acid. Heat produced by polylatic acid when burned is less than half the heat produced by polyethylene. In the ground or water, polylatic acid is subjected to spontaneous hydrolysis and turns into a nontoxic decomposition product by the action of microorganisms. Attempts are now being made to develop film sheets and containers such as bottles made from polylactic acid. Polylatic acid is a polymer formed by subjecting lactic acid to condensation polymerization.

Lactic acid has two kinds of optical isomers, i.e. L-lactic acid and D-lactic acid. Its crystallizability depends on the ratio of L-lactic acid to D-lactic acid. For example, a random copolymer, in which the ratio of L-lactic acid to D-lactic acid is about 80:20 to 20:80, has no crystallizability, and becomes a transparent, completely amorphous polymer that softens at around the glass transition point, i.e. 60° C. On the other hand, a monopolymer consisting of L-lactic acid only or D-lactic acid only has a glass transition point of about 60° C., but becomes a semicrystalline polymer having a melting point of 180° C. or over. Such a semicrystalline polymer becomes a highly transparent amorphous material by melt-extruding and rapid cooling.

There is known a method in which polylactic acid is orientated by monoaxial or biaxial stretching and then crystallized by heat treatment while suppressing growth of spherulites larger than the wavelength of visible light to maintain transparency. As industrial methods, it is possible to use for this purpose biaxial stretching devices of the roll type, tenter type or the combination type thereof, which are used for the manufacture of biaxially orientated polypropylene film and biaxially orientated polyethylene terephthalate film.

However, polylatic acid is a hard and brittle material. Thus, it may not be a suitable material according to the intended used. For example, if these unstretched polylactic acid films or biaxially orientated polylactic acid films are formed into bags, such bags are less flexible than bags made of plastic such as polyethylene and polypropylene and thus inconvenient to use.

On the other hand, flexible, biodegradable films include films made from a condensation polymer of an aliphatic multifunctional carboxylic acid and an aliphatic multifunctional alcohol. As one example, there is known a film made from an aliphatic polyester having as main structural units a dicarboxylic acid component composed of succinic acid and/or adipic acid, and a diol component composed of ethylene glycol and/or butane diol. Such an aliphatic polyester has a glass transtransition point lower than room temperature, has high crystallizability, and is crystalline at room temperature.

This polymer tends to become opaque because it is difficult to suppress growth of spherulites even if it is quickly cooled after melt extrusion. This film is thus high in non-transparency even compared with polyethylene or polypropylene film of the same thickness. If an article is put in a bag made from an aliphatic polyester, the article and its color cannot be seen clearly through the bag. This impairs display effects. While trials are being made to improve transparency even slightly by adjusting the dicarboxylic component and the diol component so as to lower crystallizability, if the crystallizability is too low, the material is less likely to solidify when cooled after extrusion, and thus more likely to stick to the cast rolls. This makes it difficult to pull it in the form of a film.

Film made from polylactic acid is hard, brittle and less flexible. On the other hand, film made from an aliphatic polyester is low in transparency. Both films have therefore room for improvement.

An object of the present invention is to provide a biodegradable film which is easily degradable in natural environment, and high in flexibility and transparency.

### SUMMARY OF THE INVENTION

According to the present invention, there is provided a biodegradable film comprising a polymer of polylactic acid family and an aliphatic polyester other than polylactic acid in a weight ratio of from 70:30 to 20:80, the film having a tensile modulus of not more than 250 kg/mm² and a light transmittance of not less than 65%, the aliphatic polyester having a number-average molecular weight of about 10000 to 150000 and the following structure:

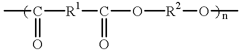

Wherein R¹ and R² are alkylene groups having 2-10 carbon atoms, cyclocyclic groups or cycloalkylene groups, and n is a degree of polymerization necessary to attain the number-average molecular weight of about 10000 to 150000.

### DETAILED DESCRIPTION OF THE PREFERRED EMBODIMENT

Polylactic acids include poly(L-lactic acid), whose structural units are L-lactic acid, poly(D-lactic acid), whose structural units are D-lactic acid, poly(DL-lactic acid), which is a copolymer of L-lactic acid and D-lactic acid, and a mixture thereof.

As a polymerization method, condensation polymerization, ring-opening polymerization or any other known method may be used. For example, in condensation polymerization, a polylactic acid having a desired composition can be manufactured by directly subjecting L-lactic acid, D-lactic acid or a mixture thereof to dehydro-condensation polymerization. In ring-opening polymerization, a lactide, which is a cyclic dimer of lactic acid, is formed into a polylactic acid using a selected catalyst and optionally a polymerization adjuster. Lactides include L-lactide, which is a dimer of L-lactic acid, D-lactide, which is a dimer of D-lactic acid, and DL-lactide, which is composed of L-lactic acid and D-lactic acid. By mixing and polymerizing them together, it is possible to manufacture a polylactic acid having desired composition and crystallizability.

Polylactic acid may be obtained by copolymerizing hydroxy-carboxylic acids with lactic acid so long as the properties of polylactic acid may not be impaired. A chain extender such as a diisocyanate compound, epoxy compound or an acid anhydride may be further added in a small amount to increase the molecular weight.

The polymer of lactic acid family should preferably have a weight-average molecular weight of 60000 to 700000. If lower than this range, desired physical properties will hardly reveal. If over this range, the melt viscosity tends to rise too high, thus worsening for mability and workability.

Polymers comprising an aliphatic carboxylic acid component and an aliphatic alcohol component (hereinafter simply referred to as “aliphatic polyesters”) may be manufactured by polymerizing them directly, or polymerizing them to the level of oligomers and then forming into a polymeric material using a chain extender.

The aliphatic polyester other than polylactic acid used in the present invention preferably comprises an aliphatic dicarboxylic acid and an aliphatic diol. Aliphatic dicarboxylic acids include such compounds as succinic acid, adipic acid, suberic acid, sebacic acid and dodecanoic acid, and their anhydrides and derivatives. On the other hand, aliphatic diols include glycol compounds such as ethylene glycol, butanediol, hexanediol, octanediol, cyclohexanedimethanol, and their derivatives. Any of them is a compound having alkylene, cycloor cycloalkylene groups having two to ten carbon atoms, and can be manufactured by condensation polymerization. Two or more of such carboxylic acid components and alcohol components may be used.

In order to improve melt viscosity by providing branches in the polymer which is aliphatic polyester, carboxylic acids, alcohol or hydroxy-carboxylic acids having a functionality of three or more may be used. If these components are used in large amounts, the polymer obtained tends to develop a crosslinked structure, lose thermoplasticity, or develop microgels having highly crosslinked structure even if thermoplasticity is maintained. Microgels tend to form fish eyes when the polymer is formed into a film. Thus, the components having a functionality of three or more should be contained in a very small amount in the polymer so as not to substantially affect the chemical and physical properties of the polymer. Such multifunctional components include malic acid, tartaric acid, citric acid, trimellitic acid, pyromellitic acid, pentaerythritol and trimethylolpropane.

The direct polymerization is a method in which the above compounds are selected and a high polymeric material is manufactured while removing water content contained in the compounds or produced during polymerization. In an indirect method, as in the manufacture of polylactic acid, a small amount of chain extender may be used to increase the molecular weight. Main chain extenders include diisocyanate compounds such as hexamethylene diisocyanate, isophorone diisocyanate, xylylene diisocyanate, and diphenylmethane diisocyanate.

Film forming conditions are described below. First, a polymer of polylactic acid family and an aliphatic polyester except polylactic acid are mixed together by putting the materials into the same extruder. There are two mixing methods, one in which the mixture is extruded through the head to directly form films, and the other in which the mixture is extruded in the form of strands to form pellets, and films are formed by passing the pellets through the extruder. In either method, decrease in the molecular weight due to decomposition has to be taken into consideration. The latter method is preferable for uniform mixing. The polymer of polylactic acid family and the aliphatic polyester except polylactic acid are dried sufficiently to remove water content, and are melted by an extruder. The temperature for extrusion is selected taking into consideration the fact that the melting point of polylatic acid varies with the ratio of L-lactic acid to D-lactic acid, and the melting point and the content of the aliphatic polyester. In practice, a temperature of about 100-250° C. is usually selected.

One important feature of the present invention is that a polymer of polylactic acid family and an aliphatic polyester except polylatic acid are mixed together in the weight ratio of from 70:30 to 20:80. If the content of the aliphatic polyester is less than 30%, the film obtained will have an insufficient shock resistance. Also, film containing less than 25% of aliphatic polyester and having the same thickness as that of plastic film used for bags are liable to be cracked or torn due to its hardness and brittleness, the properties inherent to polylactic acid. Also, because of its hardness, such film is difficult to handle.

The shock resistance as measured by use of an electro-hydraulic high-speed shock tester (HYDROSHOT made by SHIMADZU SEISAKUSYO) is preferably 100 kgf.mm or over, and more preferably 200 kgf/mm. If the content of the aliphatic polyester is less than 30%, it is possible to improve the shock resistance by adding a polymer such as an ethylene-vinyl acetate copolymer. But the addition lowers the biodegradability of the film obtained. This is thus not desirable.

Flexibility can be imparted to the film by adding an aliphatic polyester to the polylactic acid polymer. Flexibilty in terms of tensile modulus is preferably not more than 250 kg/mm², more preferably 200 kg/mm². In this connection, biaxially orientated polypropylene, which is a relatively hard material among general-purpose plastic bag materials, has a tensile modulus of about 250 kg/mm². Flexibility of such level is achievable by adding about 25% or more of an aliphatic polyester other than polylactic acid, though depending on its kind.

Ordinarily, aliphatic polyesters, especially those having a glass transition point and a crystallization point both lower than room temperature, are high in crystallizability and tend to crystallize at room temperature. And spherulites are formed inside and become cloudy. This causes the entire material to become opaque. But by adding polylactic acid, the transparency improves at least to the level of conventional polyethylene or polypropylene films.

Generally speaking, an article formed from a mixture of polymers that is low in compatibility with each other is low in transparency. But this is not the case in the present invention. In this regard, the polylactic acid and the aliphatic polyester used in the present invention are relatively high in compatibility with each other. For good transparency, the contents of the aliphatic polyester and the polylactic acid polymer should be controlled to 80% or less and 20% or over, respectively. Outside this range, transparency of the film will not improve, though this also depends on the degree of dispersion of both polymers. This is presumably due to inter-molecular interactions between both polymers, but its exact mechanism is not yet known.

The film formed should preferably have a transparency in terms of light transmittance of 65% or over, more preferably 75% or over for better transparency, though depending upon the intended use. Though depending on the thickness of the film, it is usually difficult to achieve a light transmittance of 65% or over if the content of the aliphatic polyester is over 80%. By mixing the two polymers at a ratio within the above-defined range, it is possible to form a film having both flexibility and transparency in a balanced manner.

Film may be formed by any conventional method such as a method in which a molten polymer is extruded from a T-die and solidified by rapidly cooling while taking up with a rotary casting drum, or by what is known as an inflation method, in which a molten polymer is pulled up by a cylindrical die into a cylindrical shape, and inflated like a balloon while air-cooling to form a film. But generally speaking, the latter method is disadvantageous in transparency of the film because the cooling speed is slow and thus the polymer is more likely to crystallize. For higher cooling efficiency, water may be used for cooling instead of air.

The above description is for unstretched films high in transparency and heat resistance. But the film may be stretched if necessary. For example, for use as shrink-packaging film, stretched, orientated film may be formed by the tenter or tubular method.

### EXAMPLES

Examples are shown below. They are by no means intended to limit the present invention. Measurements and evaluation shown in the Examples were carried out under the following conditions.

(1) Light Transmittance

Measurement was made under JIS K 7105. The greater the value, the higher the transparency.

(2) Tensile Modulus

Measurement was made at a temperature of 23° C. and a relative humidity of 50% using a tensile tester IM20 made by INTESCO CO.,LTD. Film was cut to strips 5 mm wide and 300 mm long, and tensile test was conducted at a tensile speed of 5 mm/min with the chuck interval set at 250 mm to measure the half strength at yield point and the strain. The tensile modulus was determined by half the strength and the strain. The smaller these values, the more flexible the film. Longitudinal and width directions of the film are indicated by MD and TD in Table 1, respectively.

(3) Shock Resistance Test

Using an electro-hydraulic high-speed shock tester (HYDROSHOT HTM-1 made by SHIMADZU SEISAKUSYO), shock resistance was measured. A film cut to 100 mm×100 mm was fixed by a clamp, shock was applied to the center of the film by a falling weight, and the destructing energy (in kgf.mm) until it breaks was read. The destructing energy was given in terms of an integrated value of the load applied to the falling weight for the falling distance (or displacement) of the falling weight to the impact point. The load-measuring temperature was 23° C. The falling speed of the falling weight was 3 m/sec.

### Example 1

Using a 25 mm dia. co-rotating compact twin-screw extruder, a polylactic acid shown in Table 1 (LACTY made by Shimazu Seisakusho Ltd.), and polybutylene succinate (Bionolle #1001 made by SHOWA HIGH POLYMER CO.,LTD), which is a condensation polymer of 1,4-butanediol and succinic acid, as an aliphatic polyester except polylactic acid, were mixed together in the weight ratio of 70:30 and melted. The molten mixture was extruded in the form of strands at 210° C. to form pellets. Then, using a 30 mm dia. compact single-screw extruder, the pellets were melt-extruded from a 30 mm dia. cylindrical die at 200° C. and air-cooled to form a 20 μm -thick inflation film having a blow ratio of 2.4. Evaluation of the films obtained is shown in Table 1.

### Example 2

A 20 μm -thick inflation film having a blow ratio of 2.5, shown in Table 1, was prepared in the same manner as in Example 1 except that polybutylene succinate/adipate (Bionolle #3001 made by SHOWA HIGH POLYMER CO LTD) formed by copolymerizing 1,4-butanediol, succinic acid and adipic acid was used instead of polybutylene succinate used in Example 1 and that the materials were mixed together in the ratio of 70:30, melted, and extruded into the shape of strands at 200° C. to form pellets.

### Examples 3, 4

Films both having a blow ratio of 2.7, shown in Table 1, were prepared in the same manner as in Example 2 except that the polylactic acid and the polybutylene succinate/adipate were mixed together in the ratios of 50:50 and 25:75, respectively.

### Comparative Example 1

An inflation film shown in Table 1 was formed solely from a polylactic acid in the same manner as in Example 2. The blow ratio was 1.9.

### Comparative Example 2

A 20 μm -thick inflation film having a blow ratio of 3.1 was formed solely from polybutylene succinate/adipate in the same manner as in Example 2 by melt-extruding it at 180° C.

### Comparative Examples 3, 4

Films shown in Table 1 were prepared in the same manner as in Example 2 except that polylactic acid and polybuthylene succinate/adipate were mixed together in the ratios of 80:20 and 15:85, respectively.

Films of Examples 1 and 2 were flexible and highly transparent, though a little too hard. Film of Example 3 was high in both transparency and flexibility. Film of Example 4 was high in flexibility though a little inferior in transparency. But they were no problem for practical use. On the other hand, films of Comparative Examples 1 and 3 lacked flexibility, though high in transparency. Films of Comparative Examples 2 and 4 were poor in transparency, though high in flexibility.

### Examples 5 and 6

### Comparative Examples 6-8

Using a dehumidifying drier, the polylactic acid used in Example 1 was dried for four hours at 120° C. The below-described aliphatic polyester and in Comparative Example 8, an ethylene-vinyl acetate copolymer (composition ratio 20:80, EVATHLENE 450P made by DAINIPPON Ink & Chemicals Inc.) were dried for 5 hours at 70° C. using a dehumidifying drier. They were mixed in the composition ratio (in weight) indicated in Table 2, melt-mixed in a 25 mm co-rotating twin-screw extruder, and water-cooled to form strands. They were then cut to form pellets. After subjecting the pellets to humidifying/drying for 6 hours at 110° C., they were put into a cast roller set at a temperature of 57° C., and cooled into a transparent sheet having a thickness of about 0.4 mm.

The aliphatic polyester used is a condensation polymer (Bionolle #1010 made by SHOWA HIGH POLYMER CO.,LTD., MFR: 9.0) comprising 1,4 butadiol and succinic acid or a condensation polymer (Bionolle #3003 made by SHOWA HIGH POLYMER CO.,LTD.) comprising 1,4 butadiol, succinic acid and adipic acid.

### Comparative Example 5

Polylactic acid dried in the same manner as in Example 4 was melt-extruded through a cap having a lip width of 300 mm by a 30 mm single-screw extruder at 210° C., put into a cast roll set at a temperature of 57° C., and colled into a transparent sheet having a thickness of about 0.4 mm. The shock resistances of the sheet is shown in Table 2.

The results of Examples 5 and 6 show that high shock resistance is obtained by adjusting the composition ratio of the polylactic acid and the aliphatic polyester within the predetermined range. In contrast, as will be apparent from Comparative Examples 5-7, if the composition ratio is out of the predetermined range, no sufficient shock resistance was obtained.

Also, Comparative Example 8 shows that even if the composition ratio is out of the predetermined range, by adding an ethylene-vinyl acetate copolymer, it was possible to improve the shock resistance compared with Comparative Example 6.

In the EXAMPLES 5 and 6, the shock resistance comparable to comparative Example 8 was obtained but without the necessity of adding ethylene-vinyl acetate copolymer.

The present invention thus provides a film easily degradable in natural environment and high in flexibility and transparency.

TABLE 1

| | Example | Example | Example | Example | Comparative | Comparative | Comparative | Comparative |
|---|---|---|---|---|---|---|---|---|
| | 1 | 2 | 3 | 4 | example 1 | example 2 | example 3 | example 4 |
| Weight ratio | | | | | | | | |
| Polylactic | 70 | 70 | 50 | 25 | 100 | 0 | 80 | 15 |
| acid | | | | | | | | |
| Aliphatic | 30 | 30 | 50 | 75 | 0 | 100 | 20 | 85 |
| polyester | | | | | | | | |
| except | | | | | | | | |
| polylactic | | | | | | | | |
| acid | | | | | | | | |
| Blow ratio | 2.4 | 2.5 | 2.7 | 2.7 | 1.9 | 3.1 | 2.7 | 2.7 |
| Tensile | | | | | | | | |
| modulus | | | | | | | | |
| kgf/mm² | | | | | | | | |
| MD | 236 | 225 | 182 | 109 | 325 | 34 | 265 | 72 |
| TD | 242 | 235 | 187 | 115 | 312 | 36 | 260 | 73 |
| Light | 78 | 85 | 81 | 68 | 94 | 53 | 87 | 56 |
| transmittance(%) | | | | | | | | |
| Total | Δ | Δ | ◯ | Δ | X | X | X | X |
| evaluation | | | | | | | | |

TABLE 2

| | | | Comparative | | | |
|---|---|---|---|---|---|---|
| | Example | | Example | | | |
| | 5 | 6 | 5 | 6 | 7 | 8 |
| Weight ratio | | | | | | |
| Polylactic acid | 65 | 65 | 100 | 80 | 80 | 70 |
| BIONOLLE #1010 | 35 | | | 20 | | 15 |
| BIONOLLE #3003 | | 35 | | | 20 | |
| EVATHLENE 450P | | | | | | 15 |
| Shock resistance (kgf · mm) | 140 | 280 | 8 | 15 | 40 | 190 |
| Total evaluation | ◯ | ⊚ | X | X | X | ◯ |

What is claimed is:

1. A biodegradable film comprising a polymer of polylactic acid family and an aliphatic polyester other than polylactic acid in a weight ratio of from 70:30 to 20:80, said film having a tensile modulus of not more than 250 kg/mm² and a light transmittance of not less than 65%, said aliphatic polyester having a number-average molecular weight of about 10000 to 150000 and the following structure: 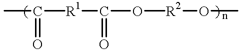
wherein R¹ and R² are alkylene groups having 2-10 carbon atoms, cyclocyclic groups or cycloalkylene groups, and n is a degree of polymerization necessary to attain the number-average molecular weight of about 10000 to 150000.
